(19) United States
(12) Patent Application Publication
(10) Pub. No.: US 2014/0019214 A1
(43) Pub. Date: Jan. 16, 2014

(54) SYSTEM AND METHOD FOR INCORPORATING INDUSTRY-WIDE DATA INTO FINANCIAL REPORTS

(71) Applicant: Michael D. Beaver, Lakeland, FL (US)

(72) Inventor: Michael D. Beaver, Lakeland, FL (US)

(21) Appl. No.: 13/939,645

(22) Filed: Jul. 11, 2013

Related U.S. Application Data
(60) Provisional application No. 61/670,241, filed on Jul. 11, 2012.

(51) Int. Cl. G06Q 10/06

(52) U.S. Cl. CPC G06Q 10/06393
USPC 705/7.39

(57) ABSTRACT

A method for incorporating industry-wide data into financial reports. One embodiment of the method comprises: building an internal financial database, wherein the internal financial database having a first data category and a first value populating the first data category; storing the internal financial database in a server, wherein the server has a processor, a display, and a network interface; receiving an external financial database, having an external financial data through the network interface; filtering external financial database using the processor; generating a financial report using the processor, wherein the steps further include: combining the first value with the plurality of third values to generate a plurality of fourth values; and sorting the plurality of fourth values; and displaying the plurality of financial reports on the display.

### CROSS REFERENCE TO RELATED APPLICATIONS

This application claims the benefit of U.S. Provisional Patent Application No. 61/670,241, filed on Jul. 11, 2012, which is incorporated by reference herein.

### TECHNICAL FIELD

The present invention relates in general to business entity financial data analysis, and more particularly to incorporating automobile industry-wide data into financial reports.

### BACKGROUND

Every month, a car dealership is faced with the task of analyzing internal financial data to prepare for the month ahead. A detailed financial analysis is needed to identify problem areas, project the sales goals, price the inventory at a competitive level, and determine whether to acquire additional inventory. This task often calls for comparing a dealership's internal performance with that of the competitor dealerships—both locally and nationally. Therefore, a need exists for an efficient system and method of incorporating automobile industry-wide data into internal financial report for a car dealership.

### SUMMARY

In accordance with one aspect of the present invention, a method and system for incorporating industry-wide data into financial reports is provided which substantially eliminates or reduces disadvantages associated with previous methods.

A method for incorporating industry-wide data into financial reports is disclosed in accordance with one embodiment. The method includes the steps of: (a) building an internal financial database, wherein the internal financial database having a first data category and a first value populating the first data category; (b) storing the internal financial database in a server, wherein the server has a processor, a display, and a network interface; (c) receiving an external financial database, having an external financial data through the network interface; (d) filtering external financial database using the processor, wherein the steps further include: selecting among a plurality of data categories a second data category that matches the first data category; determining an outlier value among a plurality of second values populating the second data category; and removing the outlier value to generate a plurality of third values; (e) generating a financial report using the processor, wherein the steps further include: combining the first value with the plurality of third values to generate a plurality of fourth values; and sorting the plurality of fourth values; and (f) displaying the plurality of financial reports on the display.

In particular embodiments, the disclosed method further includes compiling a plurality of financial reports by repeating steps (a) through (e) for the plurality of data categories in the external financial database. In some embodiments, the financial reports have a graphical component (e.g., bar graph, continuous plot, color indicators). The disclosed method also includes an option of further filtering the plurality of fourth values after the financial reports are displayed in some embodiments.

In accordance with one embodiment, a system for incorporating industry-wide data into financial reports is disclosed, where the system includes (a) an internal server having a processor, a memory, a display, an input device, and an internal financial database; (b) an external server having a processor, a memory and an external financial database; and (c) a network connection which couples the internal server with the external server. Some embodiments of the system include a client having a processor and a memory.

Certain embodiments of the present invention may provide a number of technical advantages. For example, according to one embodiment of the present invention, substantial time and effort can be saved by automating the incorporation of automobile industry-wide data into internal financial report for a car dealership. Customized financial reports can be manipulated to provide meaningful analysis and offer decision-making tips or course of action.

Another advantage in some embodiments is that real-time generation of the financial database allows subsequent financial report generation steps to be also executed in real time to provide a constantly updating year-to-date or month-to-date progress report. One need not wait until the end of the month to figure out how productive, competitive, or profitable the month has been thus far.

Certain embodiments of the present invention may enjoy some, all, or none of these advantages. Other technical advantages may be readily apparent to one skilled in the art from the following figures, description, and claims.

### BRIEF DESCRIPTION

For a more complete understanding of the present invention and its advantages, reference is made to the following description, and the accompanying drawings, in which:

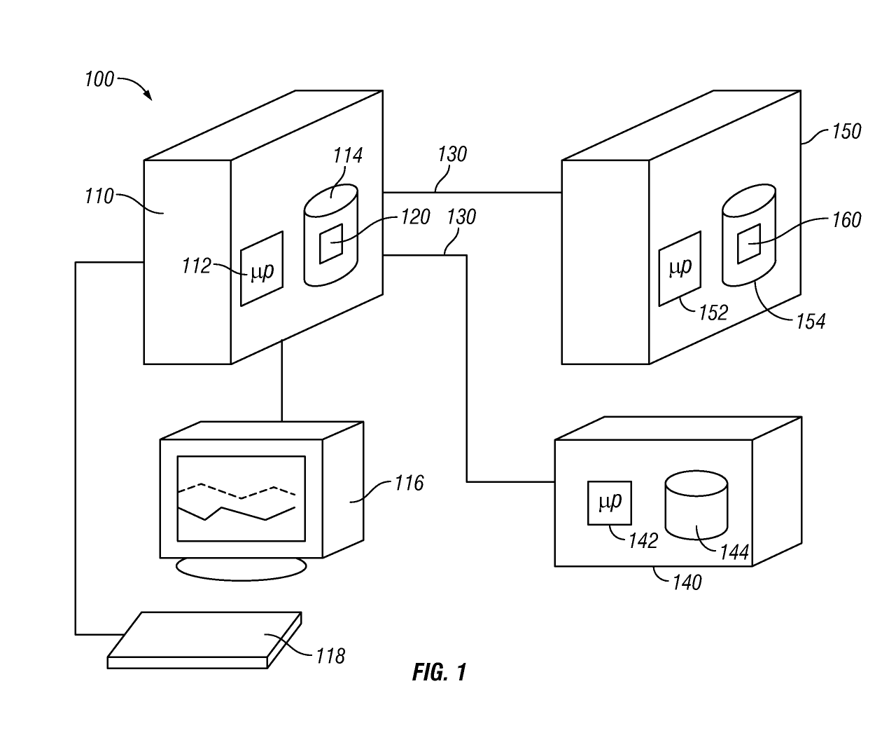

FIG. 1 illustrates industry-wide financial data incorporation system according to a particular embodiment.

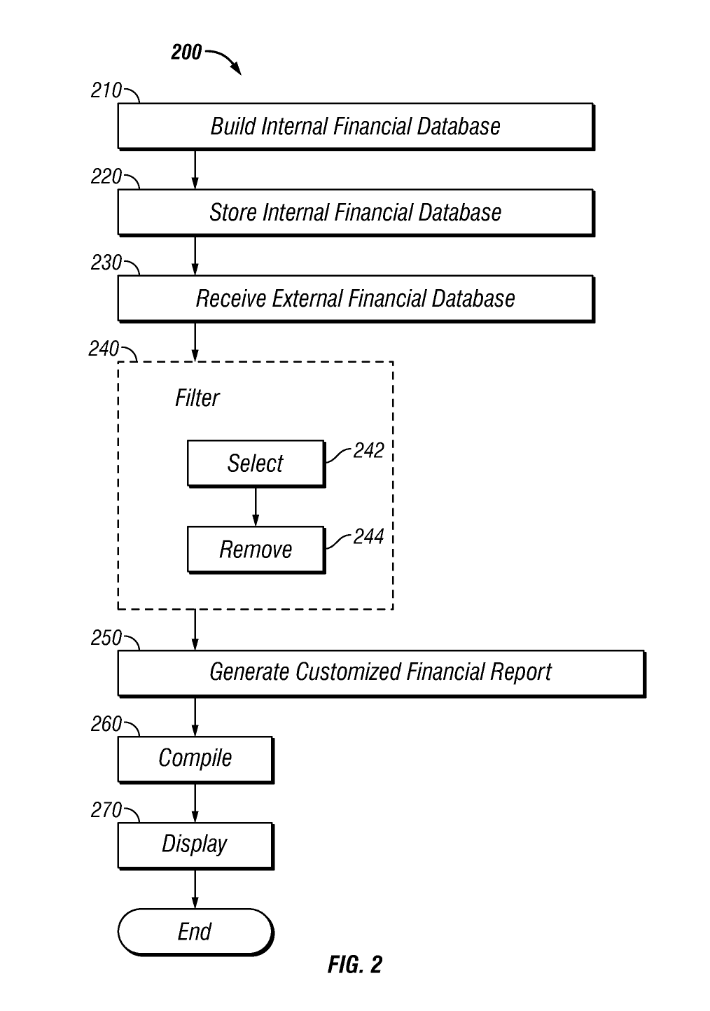

FIG. 2 illustrates industry-wide financial data incorporation method according to one embodiment.

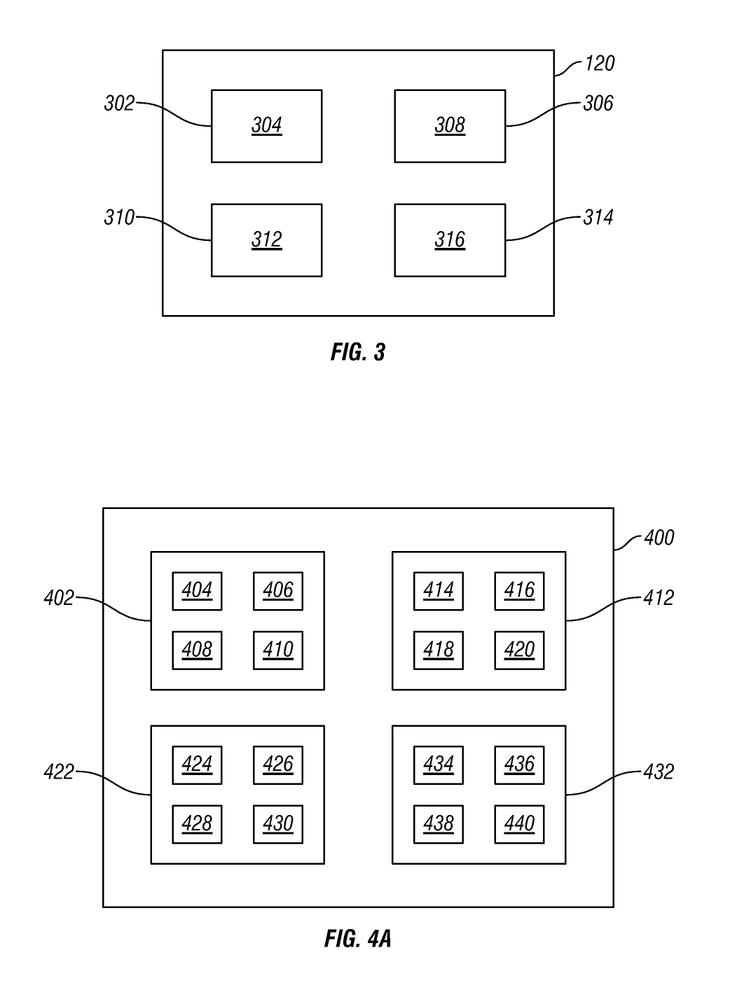

FIG. 3 illustrates internal financial database according to one embodiment.

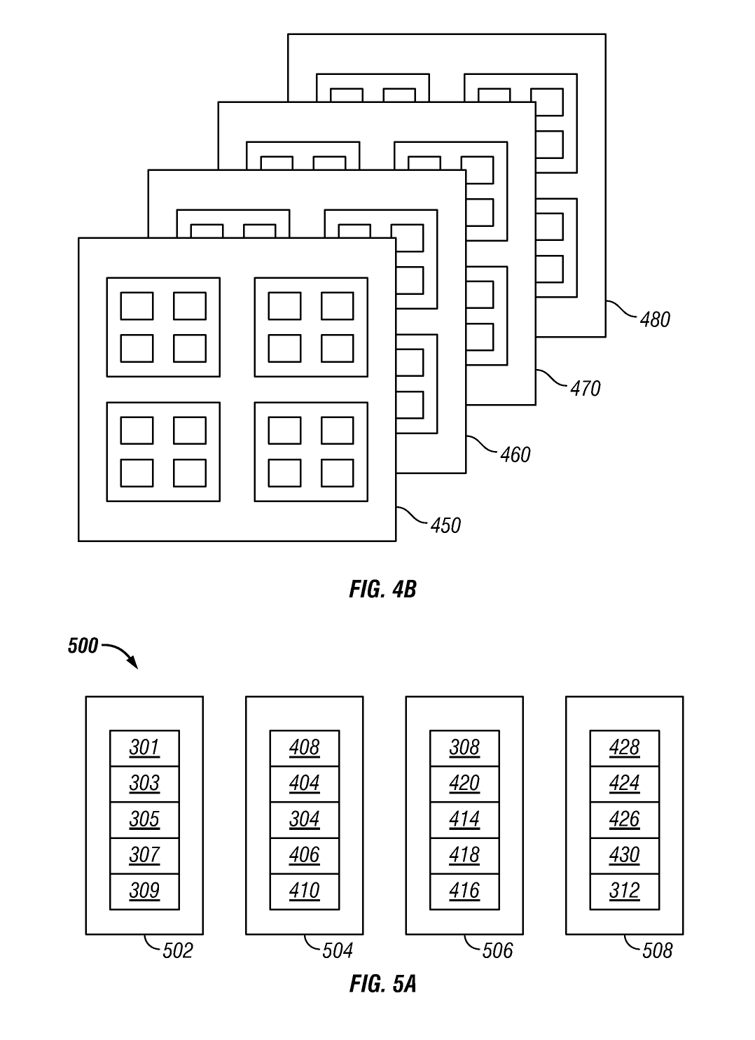

FIG. 4A illustrates external financial database according to one embodiment.

FIG. 4B illustrates external financial database according to one embodiment.

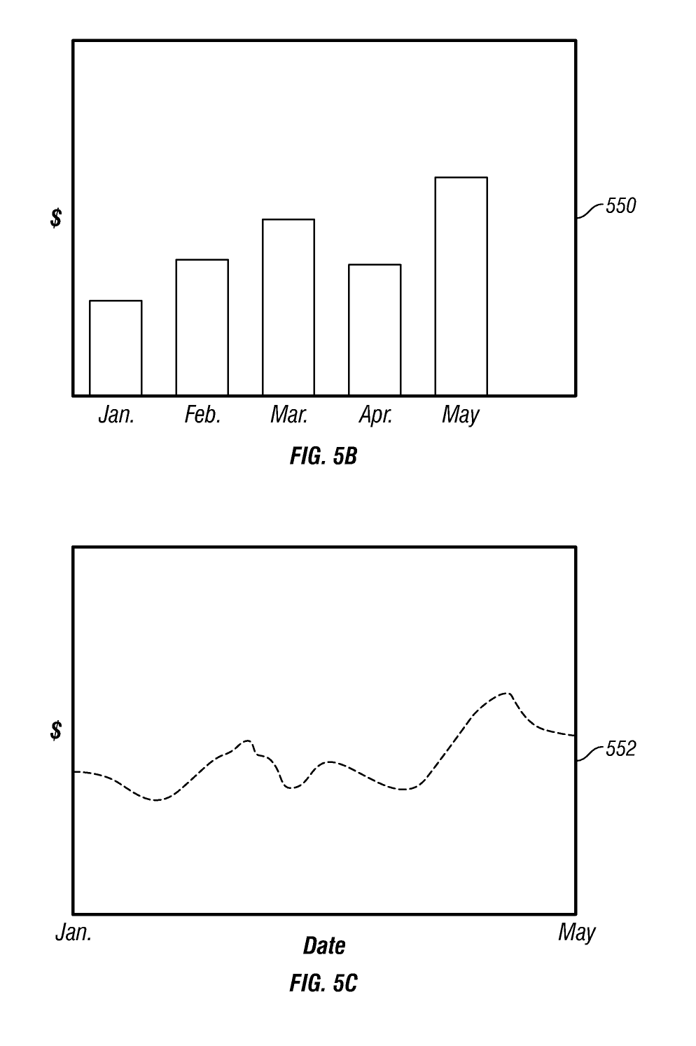

FIG. 5A illustrates customized financial report according to one embodiment.

FIG. 5B illustrates customized graphical financial report according to one embodiment.

FIG. 5C illustrates customized graphical financial report according to one embodiment.

### DETAILED DESCRIPTION

### I. System Hardware

FIG. 1 illustrates one embodiment of the industry-wide financial data incorporation system 100. System 100 includes an internal server 110, which has several components, including: a processor 112, a memory 114, a display 116, and one or more input devices 118. The memory 114 is capable of storing an internal financial database 120; the processor 112 is capable of manipulating the internal financial database 120. The processor 112 delivers textual, numerical, or graphical information to the display 116 for the end user to see. In some embodiments, the display 116 is any device capable of producing visual representation of data, including cathode-ray tube (CRT), light-emitting diode (LED) display, liquid crystal display (LCD), plasma display, electronic paper or ink display, or laser display. In various embodiments, the input devices 118 include a keyboard, a mouse, a microphone, or any other device capable of inputting data into the internal server 110.

In some embodiments, the internal server 110 is coupled via network connection 130 to one or more clients 140. The network connection 130 allows data to be transmitted to and from the internal server 110, and may be any suitable wired or wireless connection including internet, Ethernet, wireless, WiFi, WiMAX, cellular, local area networks (LAN), wide area networks (WAN), or Bluetooth. The client 140 computing unit also has a processor 142 and memory 144, and is capable of accepting data input, transmitting that data input to the internal server 110, and receiving data from the internal server 110.

The internal server 110 is coupled via a network connection 130 to an external server 150 in various embodiments. The external server 150 also includes a processor 152 and a memory 154, which are capable of manipulating and storing, respectively, the external financial database 160.

### II. Method of Incorporating Industry-Wide Data into Financial Reports

FIG. 2 illustrates one embodiment of the industry-wide financial data incorporation method 200. Method 200 begins at step 210 where system 100 builds the internal financial database 120. At step 220, system 100 stores the internal financial database 120 in the memory 114. The internal server 110 then receives the external financial database 160 at step 230. Alternatively, the internal server 110 receives the external financial database 160 before step 210 and is at least temporarily stored in the internal server 110. At step 240, system 100 filters certain data from the external financial database 160 using the processor 112. The filtering step includes at least selecting one or more outlier values at step 242 and removing them at step 244. The filtering step in other embodiments includes other operations as described further below. In some embodiments, step 240 repeats several iterations as necessary to filter out certain data. At step 250, system 100 generates one or more customized financial reports that compare or combine the internal financial database 120 with the external financial database 160. System 100 optionally compiles the one or more customized financial reports into a format readable and manipulable for a user at step 260. At step 270, system 100 transmits the compiled customized financial reports to the display 116. In some embodiments, system 100 cycles through steps 210 through 270 in more than one iteration before proceeding to step 280, where method 200 ends. Each step of method 200 is described in further detail below.

A. Step 210—Building Internal Financial Database

System 100 assembles the internal financial database 120 at step 210. As illustrated in FIG. 3, some embodiments of the internal financial database 120 includes several data categories 302, 306, 310, 314. Data categories are populated by corresponding data 304, 308, 312, 316. In at least one embodiment, the internal financial database 120 has one data category 302 with more than one datum (for example, 304 and 305 (not depicted) populating 302). In one embodiment, data categories 302, 306, 310, 314 represent specific account names used in operation and management of a car dealership. For example, data categories 302, 306, 310, 314 represent salaries, wages, sales compensation, advertising, inventory maintenance, lease income, retail vehicle sale, or wholesale transfer. In other embodiments, data categories 302, 306, 310, 314 represent a more general type of financial data used in operation and management of a car dealership. For example, in various embodiments, data categories 302, 306, 310, 314 represent accounts receivable, inventories, accounts payable, overhead expenses, accrued liabilities, long-term debt, total assets, total liability, or net worth. In alternative embodiments, a data category is an operation of one or more other data category. For example, net worth 302 is calculated by total assets 306 minus total liabilities 310. In another embodiment, a data category is an operation of one or more datum populating the category. For example, total asset 314 is a sum total of cash account 316, accounts receivables 317 (not depicted), inventories 318 (not depicted), fixed assets 319 (not depicted), and other assets 320 (not depicted), where 316, 317, 318, 319, 320 are data populating the data category 314.

In one embodiment of step 210, the system 100 assembles the internal financial database 120 in real time as various transactions occur. One advantage of assembling the internal financial database 120 in real time is that the subsequent steps can also be executed in real time to provide a constantly updating month-to-date or year-to-date progress report. Often, account balance is updated as transactions occur, thus the real-time database assembly embodiment reflects the accounting practices. Alternatively, system 100 assembles the entire monthly internal financial database 120 at the end of a month. One advantage of this alternative is the ability to compare month-to-month financial performance as well as year-over-year performance.

B. Step 220—Storing Internal Financial Database

At step 220, system 100 stores the internal financial database 120 in the memory 114 (see FIG. 1). In various embodiments, the memory 114 is a hard drive, random access memory (RAM), read-only memory (ROM), compact disc, magneto-optical storage device, solid-state disk, fixed memory medium, removable memory medium, or any other memory device capable of storing the internal financial database 120.

In at least one embodiment, the processor 112 is able to call upon the internal financial database 120 stored in the memory 114. In some embodiments, processor 112 conducts one or more operation to edit or update the stored internal financial database 120. The changes are again stored in the memory 114. In other words, steps 210 and 220 cycle through several iterations in some embodiments.

C. Step 230—Receiving External Financial Database

At step 230, internal server 110 receives the external financial database 160. Alternatively, the internal server 110 receives the external financial database 160 before step 210 and is at least temporarily stored in the internal server 110.

In various embodiments, the external financial database 160 is generated by various entities in the industry. In one embodiment, for example, the external financial database 160 is internal financial database 120 generated by one or more sister dealerships in a family of automobile dealerships owned by a common holding company. Comparing the internal financial database 120 among various dealerships may be advantages for the management of the holding company in evaluating strengths and weaknesses of a particular dealership or geographic market. In another embodiment, the external financial database 160 is an industry-wide database assembled by a third-party entity. For example, the National Automobile Dealers Association (NADA) produces composite database of new and used automobile dealerships across the Unites States. Particularly, the NADA 20 Group periodically produces composite database which covers particular type of dealership (e.g., automobile brand, new versus used, geographic region, dealership size, etc.). In some embodiment, the external financial database 160 is financial information of various companies in the automotive industry. Such companies may include various automobile manufactures (e.g., Ford, General Motors, Toyota, etc.), parts manufacturers (e.g., Goodyear, Delphi Automotive, 3M, etc.), or raw material supplier (e.g., Alcoa, U.S. Steel, Bridgestone, etc.). This information can be obtained from Securities and Exchange Commission (SEC) filings or the companies' publically traded stock information. In another embodiment, the external financial database 160 is an economic indicator, such as Dow Jones Industrial Average, NASDAQ Composite Index, New York Stock Exchange (NYSE) Composite Index, or London Metal Exchange (LME).

How often system 100 performs step 230 varies depending on the source and type of the external financial database 160. For example, if the external financial database 160 is from a sister dealership, the updated database can be transmitted and received daily or on a monthly basis. If the external financial database 160 is from an industry association, like NADA, system 100 performs step 230 as frequently as the NADA database is published. Stock prices or economic indices update on a nearly constant basis throughout the business day, thus step 230 can be performed as frequently or on a daily basis.

In some embodiments, system 100 receives the external financial database 160 from the external server 150 via the network connection 130 (see FIG. 1). The external financial database 160 is at least temporarily stored in the memory 114 to enable subsequent steps. In various embodiments, the external server 150 is a server maintain the entity producing the external financial database 160 (e.g., a sister dealership, NADA 20 Group, SEC, or NYSE).

In other embodiments, the external financial database 160 is produced and distributed in hard-copy form. For example, the NADA 20 Group's composite database is a booklet of relevant industry data in columnar format. To incorporate this data, in one embodiment, a user manually transcribes the data from the hard-copy form into the internal database 120 using the input device 118. In an alternative embodiment, the transcription takes place at the client 140, which is coupled to the internal server 110 via network connection 130. In another embodiment, the external financial database 160 in hard-copy form is digitally scanned into the system 100 and subsequently converted into manipulable data format using original character recognition (OCR) technologies.

D. Step 240—Filtering

At step 240, system 100 filters certain data from the external financial database 160. In some embodiments, external financial database 160 contains unwanted data. The unwanted data is an outlier data value within a particular data category 302 in one embodiment. System 100 selects the outlier data value at step 242 and removes it from the external financial database 160 at step 244. One advantage of filtering out unwanted data from the external financial database 160 is the ability to analyze the effect of the outlier data value.

Selecting the data value to be removed at step 242 may be automated or initiated by the user depending on the embodiment. In one of the automated embodiments, for example, system 100 filters any data outside a threshold minimum, maximum, or standard deviation value. On the other hand, in a user-initiated embodiment, the user inputs a desired minimum, maximum, or standard deviation value, and system 100 filters that any data outside the range. In another embodiment, the user dictates a known data value to be filtered.

In some embodiments, system 100 overwrites the original external financial database 160 with the filtered database. In another embodiment, system 100 leaves the original extra mile financial database 160 intact, but creates a duplicate before filtering out the unwanted data. System 100 overwrites the duplicate with the filter results. One advantage of creating a duplicate, as the ability to generate the financial without filtering data from the external financial database 160.

In some embodiments, the external financial database 160 is accumulated over time; as new data become available, the database 160 is updated. FIG. 4A illustrates one embodiment of a new set of data 400 to be incorporated into the accumulated external financial database 160. The new data set 400 contains various data categories 402, 412, 422, 432. In one embodiment, as illustrated in FIG. 4A, each data category contains multiple data values. For example, data category 402 represents net profit and contains data values 404, 406, 408, 410 from various entities that reported their net profit. The accumulated external financial database 160 is illustrated in FIG. 4B according to one embodiment. The external financial database 160 contains various sets of data 450, 460, 470, 480 that were incorporated into the external financial database 160 at different times. For example, data sets 450, 460, 470, 480 represent the financial database from four quarters of a fiscal year, Q1, Q2, Q3, Q4, respectively.

One advantage of accumulating data sets from external financial database 160 is the ability to internally analyze market and industry changes over time without the need to rely on third-party analysts. For example, NADA may release its industry-wide database on a monthly basis but not conduct a yearly analysis until the end of a fiscal year. Compiling the monthly databases into an accumulated external financial database 160 allows for a year-to-date analysis—with or without data filtering—even before other players in the industry receive the yearly analysis from NADA.

E. Step 250—Generating Customized Financial Report

System 100 generates one or more customized financial reports 500 at step 250 as illustrated in FIG. 5A according to one embodiment. In some embodiments, external financial database data categories 402, 412, 422, 432 (FIG. 4A) correspond to the internal financial database data categories 302, 306, 310, 314, respectively. To generate a customized financial report 500, system 100 combines data from internal financial database 120 with data from external financial database 160 according to corresponding data categories.

In one embodiment, the correlation is naturally determined by the type of data category. For example, the internal data category 302 that represents total operating expense for new vehicle department would be compared with the external data category 402 that represents industry-wide data on new vehicle operating expense analysis. System 100 combines the internal data value 304 with the external data values 404, 406, 408, 410 to generate financial report 500 (see FIG. 5A).

In one embodiment, system 100 sorts the combined data in the financial report 500 in ascending or descending order. In other embodiments, system 100, using the microprocessor 112, calculates mean, median, mode, or percentile values of the combined data in the financial report 500. In some embodiments, the calculated mean, median, or mode values are populated and combined into the financial report 500 data. One advantage of these data manipulation methods is the ability to quickly and efficiently compare internal financial performance to that of other industry players.

In alternative embodiments, the correlation is determined by the predefined or userdefined instructions. For example, the internal data category 306 that represents parts department inventory expenses would be compared with the external data category 412 that represents industry-wide steel, rubber, or plastic prices.

In at least one embodiment, the customized financial report 500 is a compilation of data from internal financial database 120 over a particular time period. For example, it may be beneficial to analyze the monthly performance gross profit of new vehicle department. To that end, system 100 generates the customized financial report 502, which includes several data values 301, 303, 305, 307, 309 the new vehicle department gross profit data from January, February, March, April, and May, respectively. This report 502 can be sorted chronologically or in ascending or descending order to evaluate which month showed strongest performance.

In other embodiments, system 100 generates the customized financial report in a graphical format 550, 552 as illustrated in FIGS. 5B and 5C. Taking the new vehicle department gross profit example, the months are plotted on the x-axis and the profit amount is plotted on the y-axis to show relative monthly performance in new vehicle department gross profit 550 over time (FIG. 5B). In an alternative embodiment, the daily profit values can be plotted to show continuous change 552, and the area under the curve would represent year-to-date performance (FIG. 5C).

F. Step 260—Compiling Customized Financial Report

In some embodiments, system 100 generates multiple customized financial reports 502, 504, 506, 508 (see FIG. 5A) In such embodiments, system 100 compiles the one or more customized financial reports into a format readable and manipulable for a user at step 260. In some embodiments, system 100 generates a list of compiled customized financial reports 500 to assist a user to easily navigate between several reports.

G. Step 270—Displaying Customized Financial Report

At step 270, system 100 displays the customized financial report 500 by transmitting it to the display 116. In some embodiments, the user—at either the internal server 110 or the client 140—further manipulates the displayed customized financial report 500 as desired. For example, the user may desire to sort the data in descending order rather than ascending order as displayed. At least one embodiment of system 100 includes menu buttons that allow the user to sort the data values as desired.

In some embodiments, the displayed customized financial report 500 includes color indicators to further aid the user in financial analysis. For example, customized financial report 508 (FIG. 5A) represents net profit of dealership, wherein data value 312 is the internal net profit figure. When sorted in descending order (i.e., highest profit at the top), system 100 assigns the internal net profit value 312 a color indicator based on relative strength compared to the other data values in the report 508. In the example illustrated, the internal net profit value is the lowest among the data values, so system 100 assigns a warning color that will alert the user (e.g., red or orange). Conversely, if report 508 were to represent overhead expenses, system 100 would assign a positive color (e.g., green or blue). In some embodiments, system 100 selects the color indicators automatically based on the data category; in other embodiments, system 100 allows the user to select the desired color indicator.

In at least one embodiment, system 100 allows the user to manually filter data from the external financial database 160 by choosing a menu button on the displayed customized financial report 500. System 100 filters the selected data only temporarily in some embodiments; in other embodiments, the user-initiated data filtering information is incorporated and stored in either the original or duplicate external financial database 160 (in similar ways as some embodiments of filtering step 240 described above).

Although the present invention has been described with several embodiments, a myriad of changes, variations, alterations, transformations, and modifications may be suggested to one skilled in the art, and it is intended that the present invention encompass such changes, variations, alterations, transformations, and modifications as fall within the spirit and scope of the appended claims. Alternative embodiments that result from combining, integrating, or omitting features of the embodiments are also within the scope of the disclosure.

In order to assist the United States Patent and Trademark Office (USPTO) and any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this invention in any way that is not otherwise reflected in the appended claims.

What is claimed is:

1. A method for incorporating industry-wide data into financial reports, comprising:
a) building an internal financial database, wherein the internal financial database comprises a first data category and a first value populating the first data category;
b) storing the internal financial database in a server, wherein the server comprises a processor, a display, and a network interface;
c) receiving an external financial database comprising an external financial data through the network interface;
d) filtering external financial database using the processor comprising:
selecting among a plurality of data categories a second data category that matches the first data category;
determining an outlier value among a plurality of second values populating the second data category; and
removing the outlier value to generate a plurality of third values;
e) generating a financial report using the processor comprising:
combining the first value with the plurality of third values to generate a plurality of fourth values; and
sorting the plurality of fourth values; and
f) displaying the plurality of financial reports on the display.

2. The method of claim 1 further comprising compiling a plurality of financial reports by repeating steps (a) through (e) for the plurality of data categories in the external financial database.

3. The method of claim 1 wherein the plurality of financial reports further comprises a graphical component.

4. The method of claim 1 wherein the plurality of fourth values is further filtered.

5. A computer program product, comprising a computer usable medium having computer readable program code embodied therein, the computer readable program code adapted to be executed to implement a method for incorporating industry-wide data into financial reports, comprising:
a) building an internal financial database, wherein the internal financial database comprises a first data category and a first value populating the first data category;
b) storing the internal financial database in a server, wherein the server comprises a processor, a display, and a network interface;
c) receiving an external financial database comprising an industry-wide financial data through the network interface;
d) filtering external financial database using the processor comprising:
selecting among a plurality of data categories a second data category that matches the first data category;
determining an outlier value among a plurality of second values populating the second data category; and
removing the outlier value to generate a plurality of third values;
e) generating a financial report using the processor comprising:
combining the first value with the plurality of third values to generate a plurality of fourth values; and
sorting the plurality of fourth values; and
f) displaying the plurality of financial reports on the display.

6. A system for incorporating industry-wide data into financial reports, comprising:
a) an internal server comprising a processor, a memory, a display, an input device, and an internal financial database;
b) an external server comprising a processor, a memory and an external financial database; and
c) a network connection which couples the internal server with the external server.

7. The system of claim 6 further comprising a client comprising a processor and a memory.
